(19) United States
(12) Patent Application Publication
(10) Pub. No.: US 2019/0164417 A1
(43) Pub. Date: May 30, 2019

(54) ESTIMATING TIME TRAVEL DISTRIBUTIONS ON SIGNALIZED ARTERIALS

(71) Applicant: Uber Technologies, Inc., San Francisco, CA (US)

(72) Inventors: J.D. Margulici, Santa Clara, CA (US); Kevin Adda, Santa Clara, CA (US); André Guéziec, Sunnyvale, CA (US); Edgar Rojas, Santa Clara, CA (US)

(21) Appl. No.: 16/195,439

(22) Filed: Nov. 19, 2018

Related U.S. Application Data
(62) Division of application No. 14/058,195, filed on Oct. 18, 2013, now Pat. No. 10,223,909.
Application No. 14/058,195 is a continuation-in-part of application No. 13/752,351, filed on Jan. 28, 2013, now Pat. No. 8,781,718.
(60) Provisional application No. 61/715,713, filed on Oct. 18, 2012.

(51) Int. Cl. G08G 1/01

(52) U.S. Cl. CPC G08G 1/0112; G08G 1/0129; G08G 1/0116

(57) ABSTRACT

Systems and methods are provided for estimating time travel distributions on signalized arterials. The systems and methods may be implemented as or through a network service. Traffic data regarding a plurality of travel times on a signalized arterial may be received. A present distribution of the travel times on the signalized arterial may be determined. A prior distribution based on one or more travel time observations may also be determined. The present distribution may be calibrated based on the prior distribution.

### CROSS-REFERENCE TO RELATED APPLICATION

This application is a continuation-in-part of U.S. application Ser. No. 13/752,351, filed on Jan. 28, 2013 and title “Estimating Time Travel Distributions on Signalized Arterials,” the disclosure of which is incorporated herein by reference. This application also claims the priority benefit of U.S. provisional application No. 61/715,713, filed on Oct. 18, 2012 and titled “Estimation of Time Travel Distributions on Signalized Arterials,” the disclosure of which is incorporated herein by reference.

### BACKGROUND

### Field of Invention

The present disclosure generally concerns traffic management. More specifically, the present disclosure concerns estimating time travel distributions on signalized arterials and thoroughfares.

### Description of Related Art

Systems for estimating traffic conditions have historically focused on highways. Highways carry a majority of all vehicle-miles traveled on roads and are instrumented with traffic detectors. Notably, highways lack traffic signals (i.e., they are not “signalized”). Estimating traffic conditions on signalized streets represents a far greater challenge for two main reasons. First, traffic flows are interrupted because vehicles must stop at signalized intersections. These interruptions generate complex traffic patterns. Second, instrumentation amongst signalized arterials is sparse because the low traffic volumes make such instrumentation difficult to justify economically.

In recent years, however, global positioning system (GPS) connected devices have become a viable alternative to traditional traffic detectors for collecting data. As a result of the permeation of GPS connected devices, travel information services now commonly offer information related to arterial conditions. For example, travel information services provided by Google Inc. of Mountain View, Calif. and Inrix, Inc. of Kirkland, Wash., are known at this time. Although such information is frequently available, the actual quality of the traffic estimations provided remains dubious.

Even the most cursory of comparisons between information from multiple service providers reveals glaring differences in approximated signalized arterial traffic conditions. The low quality of such estimations is usually a result of having been produced from a limited set of observations. Recent efforts, however, have sought to increase data collection by using re-identification technologies.

Such techniques have been based on be based on magnetic signatures, toll tags, license plates, or embedded devices. The sampling sizes obtained from such technologies are orders of magnitude greater than those obtained from mobile GPS units. Sensys Networks, Inc. of Berkeley, Calif., for example, collects arterial travel time data using magnetic re-identification and yields sampling rates of up to 50%. Notwithstanding these recently improved observation techniques, there remains a need to provide more accurate estimates of traffic conditions on signalized arterials.

### SUMMARY

A system for estimating time travel distributions on signalized arterials may include a processor, memory, and an application stored in memory. The application may be executable by the processor to receive data regarding travel times on a signalized arterial, estimate a present distribution of the travel times, estimate a prior distribution based on one or more travel time observations, and calibrate the present distribution based on the prior distribution. In some embodiments, the system may further include estimating traffic conditions for a particular signalized arterial segment and displaying the estimates to a user through a graphical interface of a mobile device.

A method for estimating time travel distributions on signalized arterials may include receiving travel data and executing instructions stored in memory. Execution of the instructions by a computer processor may estimate a distribution based on the travel data and calibrate the distribution. In some embodiments, the method may further include estimating traffic conditions for a particular signalized arterial segment and displaying the estimates to a user through a graphical interface of a mobile device.

### BRIEF DESCRIPTION OF DRAWINGS

FIG. 1 is a block diagram of a system for estimating time travel distributions on signalized arterials.

FIG. 2 is a series of maps 200 highlighting exemplary signalized arterial segments that may be analyzed using the technology disclosed herein.

FIG. 3 is a series of graphs showing distributions of pace on a signalized arterial segment at the same time on over three consecutive days.

FIG. 4 is a graph showing variations in pace throughout different times periods time periods in a day.

FIG. 5 is another graph showing variations in pace throughout different time periods in a day.

FIG. 6 is another graph showing variations in pace throughout different time periods in a day.

FIG. 7 is another graph showing variations in pace throughout different time periods in a day.

FIG. 8 is series of histograms showing that illustrates the diversity of possible distribution shapes generated by the system and methods disclosed herein.

FIG. 9 is another series of graphs showing the distribution of certain parameters for two consecutive time slots from approximately 30 days of data.

FIG. 10 is a series of graphs showing an exemplary quantile distribution.

FIG. 11 is yet series of graphs showing an exemplary quantile distribution.

FIG. 12 is a series of scatter plots mapping quantiles against one another.

FIG. 13 is another series of scatter plots mapping quantiles against one another.

FIG. 14 is a block diagram of a device for implementing an embodiment of the presently disclosed invention.

FIG. 15 shows an exemplary method for estimating traffic on signalized arterials.

### DETAILED DESCRIPTION

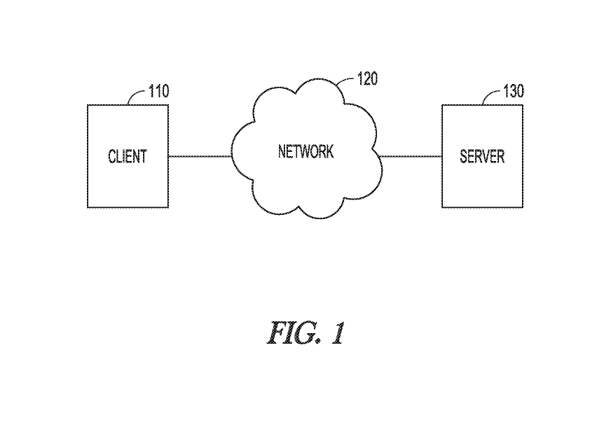

FIG. 1 is a block diagram of a system for estimating time travel distributions on signalized arterials. The system of FIG. 1 includes a client computer 110, network 120, and a server 130. Client computer 110 and server 130 may communicate with one another over network 120. Client computer 110 may be implemented as a desktop, laptop, work station, notebook, tablet computer, smart phones, mobile device or other computing device. Network 120 may be implemented as one or more of a private network, public network, WAN, LAN, an intranet, the Internet, a cellular network or a combination of these networks.

Client computer 110 may implement all or a portion of the functionality described herein, including receive traffic data and other data or and information from devices using re-identification technologies. Such technologies may be based on magnetic signatures, toll tags, license plates, or embedded devices, such as Bluetooth receivers. Notably, sampling sizes obtained from such technologies can be orders of magnitude greater than those obtained from mobile GPS units. Notwithstanding that fact, server 130 may also receive probe data from GPS-connected mobile devices. Server 130 may communicate data directly with such data collection devices. Server 130 may also communicate, such as by sending and receiving data, with a third-party server, such as the one maintained by Sensys Networks, Inc. of Berkeley, Calif. and accessible through the Internet at www.sensysresearch.com.

Server computer 130 may communicate with client computer 110 over network 120. Server computer may perform all or a portion of the functionality discussed herein, which may alternatively be distributed between client computer 110 and server 130, or may be provided by server 130 as a network service for client 110. Each of client 110 and server computer 130 are listed as a single block, but it is envisioned that either be implemented using one or more actual or logical machines.

In one embodiment, the system may utilize Bayesian Inference principles to update a prior belief based on new data. In such an embodiment, the system may determine the distribution of travel times y on a given signalized arterial at the present time T. The prior beliefs may include the shape of the travel time distribution and the range of its possible parameters θ_{T} (e.g., mean and standard deviation) that are typical of a given time of day, such that y follows a probability function p(y|θ_{T}). These parameters themselves may follow a probability distribution p(θ_{T}|α_{T}T) called the prior distribution. The prior distribution may comprise its own set of parameters α_{T}, which are referred to as hyper-parameters.

The system may estimate the current parameters using a recent (e.g., 20 minutes ago or less in some embodiments) travel time observation of the arterial of interest. The system may also account for observations on neighboring streets. In still further embodiments, the system may consider contextual evidence such as local weather, incidents, and special events such as sporting events, one off road closures, or other intermittent traffic diversions. In one embodiment, yᵢ* may designate the current travel time observations. The system may determine the likeliest θ_{T} using a known yᵢ* and α_{T}.

The system 100 may account for one or more travel time variability components. First, there may be individual variations between vehicles traveling at the same time of day. These variations stem from diverse driving profiles among drivers and their varying luck with traffic signals. Second, there may be recurring time-of-day variations that stem from fluctuating traffic demand patterns and signal timing. Third, there may be daily variations in the distributions of travel times over a given time slot. System 100 may account for other time travel variability components.

In one exemplary embodiment, the system 100 may employ standard Traffic Message Channel (TMC) location codes as base units of space, and fifteen-minute periods as base units of time. In such an embodiment, the system 100 approximates that traffic conditions remain homogeneous across a given TMC location code over each fifteen-minute period. The system 100 may also use other spatial or temporal time units depending on the degree of precision desired. For example, the system 100 may use a slightly coarser scale for the base units of space (e.g., segments a few miles or kilometers long) to mitigate noise in the travel time data. Alternatively, the system 100 may use reidentification segments as the base units in the space domain. In such embodiments, the system 100 approximates that traffic conditions remain homogenous across a given reidentification segment over each fifteen-minute period. System 100 may also normalize travel time data into a unit of pace that is expressed in seconds per mile or seconds per kilometer. The system 100 may also calculate the average pace as a linear combination of individual paces weighted by distance traveled. Such calculations may be more convenient than using speed values.

System 100 may generate thousands of data plots of various types. For example, system 100 may generate boxed plots that represent the dispersion of travel times along a segment at various times of day. Those plots can be built either for a single day or by aggregating multiple days. System 100 may also generate travel time histograms that represent the distribution of travel times for a given slice of the data—typically a particular segment and time slot, either for a single day or multiple days taken in aggregate. The travel time histograms may be produced in at least series of three types: time-of-day singles, which show a single day's sequence in fifteen minute increments; time-of-day aggregates, which show time-of-day variations using an aggregate of multiple days; and daily time slot plots, which show the same time slot over multiple days. In various embodiments, other series types may likewise be generated and analyzed in accordance with the system and methods disclosed herein.

System 100 may also generate parameter plots, which represent the variations of key distribution parameters such as the min, max, 25^{th} 50^{th}, or 75^{th} percentile or given interpercentiles as histograms. Parameter plots may be generated in at least three different ways: time-of-day parameter plots, which represent percentile variations during the day for each individual date; daily time slot parameter plots, which represent percentile variations across different days for every time slot; and density maps, which are two-dimensional plots of one percentile versus another for a given set of time slots and dates.

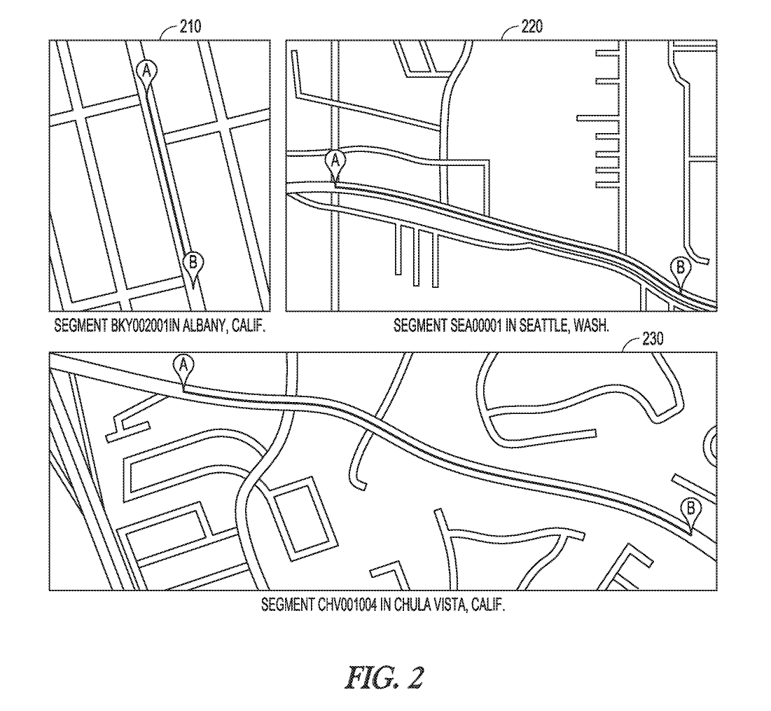

FIG. 2 is a series of maps 200 highlighting exemplary signalized arterial segments that may be analyzed using the technology disclosed herein. Map 210 shows exemplary signalized arterial segment “BKY002001” located in Albany, Calif. Map 220 shows exemplary signalized arterial segment “SEA000001” located in Seattle, Wash. Map 230 shows exemplary signalized arterial segment “CHV001004” located in Chula Vista, Calif.

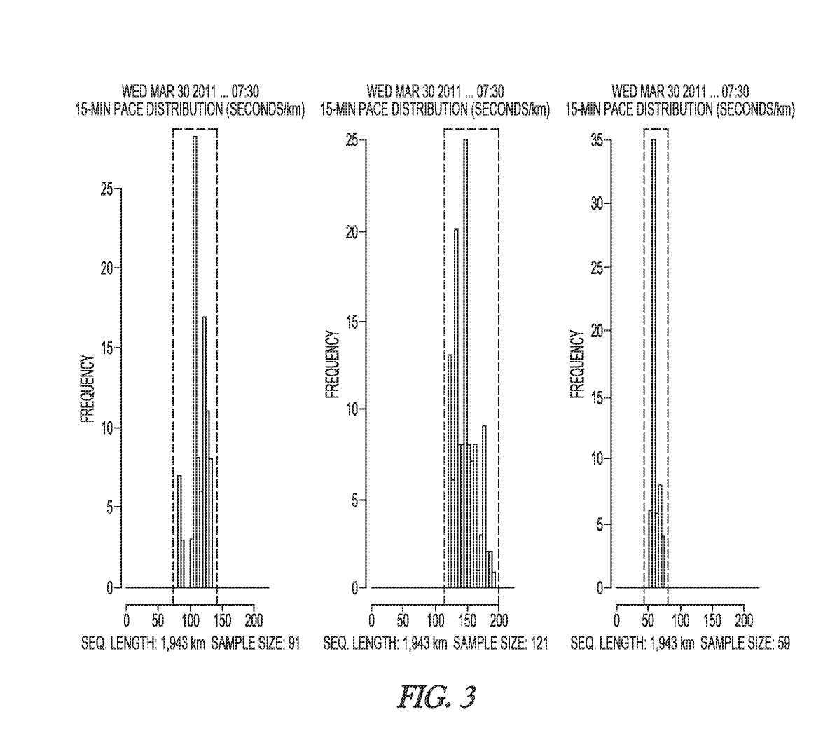

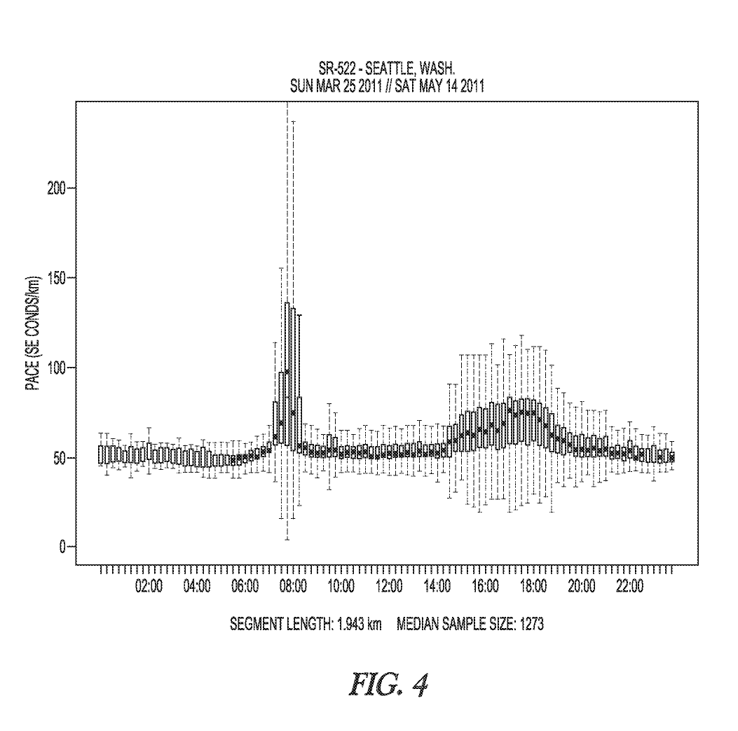

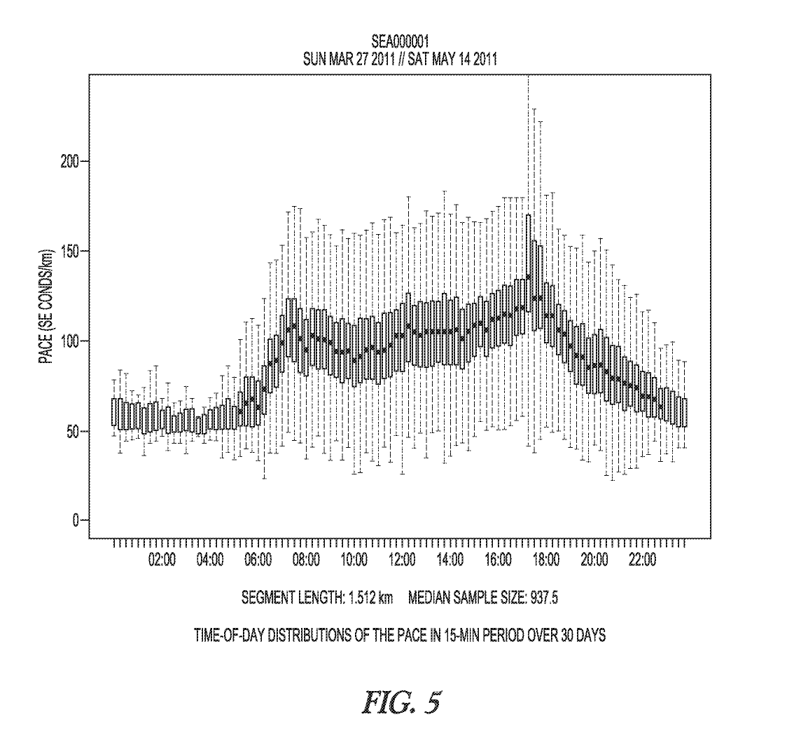

FIG. 3 is a series of graphs showing distributions of pace on a signalized arterial segment at the same time on over three consecutive days. More specifically, FIG. 3 shows an exemplary distribution of pace on a 2-km arterial segment in Seattle, Wash. for the same fifteen-minute time period on three consecutive days. As suggested in FIG. 3, determining an exact distribution shape for a given fifteen minute period on any given day may pose a difficult objective. The presently described system can, however, directly observe three different states of an arterial segment and then calibrate the prior probabilities of being in either state from archived data. The system may also use real-time data to help refine a given belief regarding which of the multiple states applies to the real-time prediction.

FIG. 4 is a graph showing variations in pace throughout different times periods in a day. As shown in FIG. 4, the presently disclosed system may account for time-of-day variations. Notably, the box indicates the 25^{th}, 50^{th}, and 75^{th} percentile value while the dotted lines extend to extreme values. In such embodiments, the system may use data regarding regular patterns of increase and decrease in travel times to calibrate prior distributions by time of day.

FIG. 5 is another time-of-day distribution graph showing variations in pace throughout different time periods in a day. More specifically, FIG. 5 shows a boxed plot of travel time dispersion by time of day across approximately 30 days in fifteen minute intervals. As in FIG. 4, the boxes indicate the 25^{th}, 50^{th} (black dot), and 75^{th} percentiles, while the dotted lines or “whiskers” extend to the minimum and maximum.

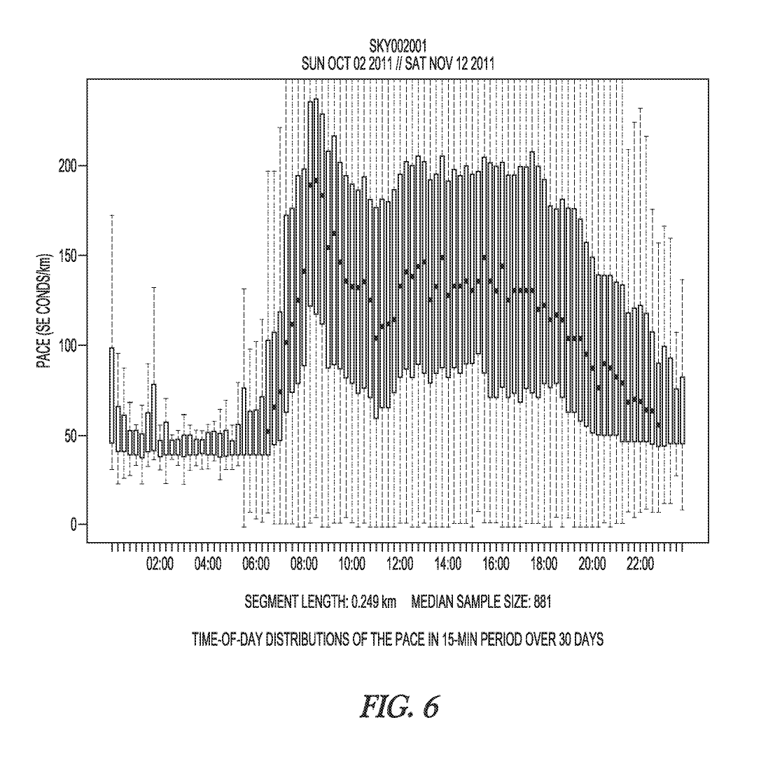

FIG. 6 is yet another graph showing variations in pace throughout different time periods in a day. FIG. 6 represents an exemplary data set from a different arterial segment than that illustrated in FIGS. 4 and 5. Namely, FIGS. 4 and 5 illustrate an exemplary data set from segment SEA000001 in Seattle, Wash., while FIG. 6 illustrates an exemplary data set from segment BKY002001 in Albany, Calif. As in FIGS. 4 and 5, the boxes indicate the 25^{th}, 50^{th} (black dot), and 75^{th} percentiles, while the dotted lines or “whiskers” extend to the minimum and maximum.

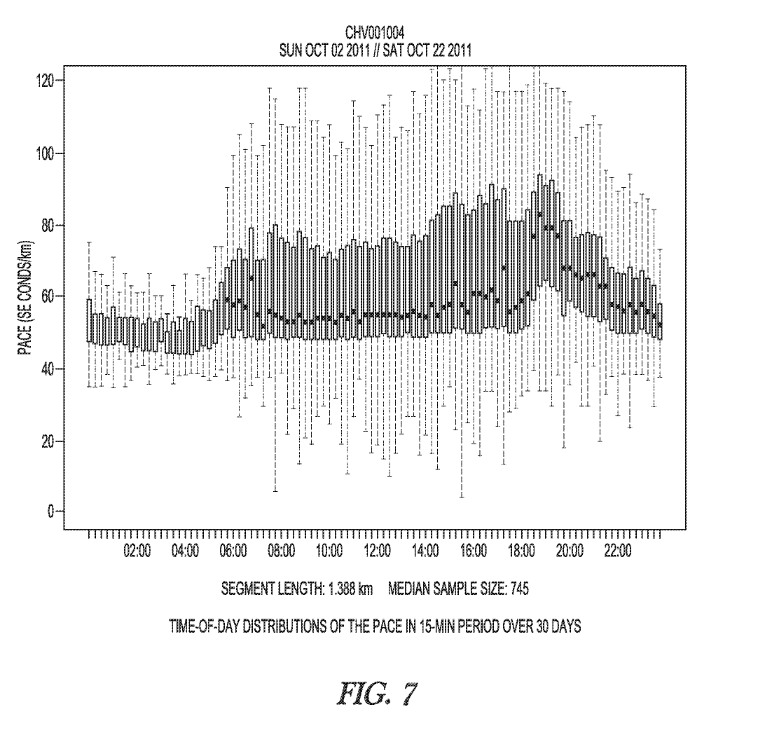

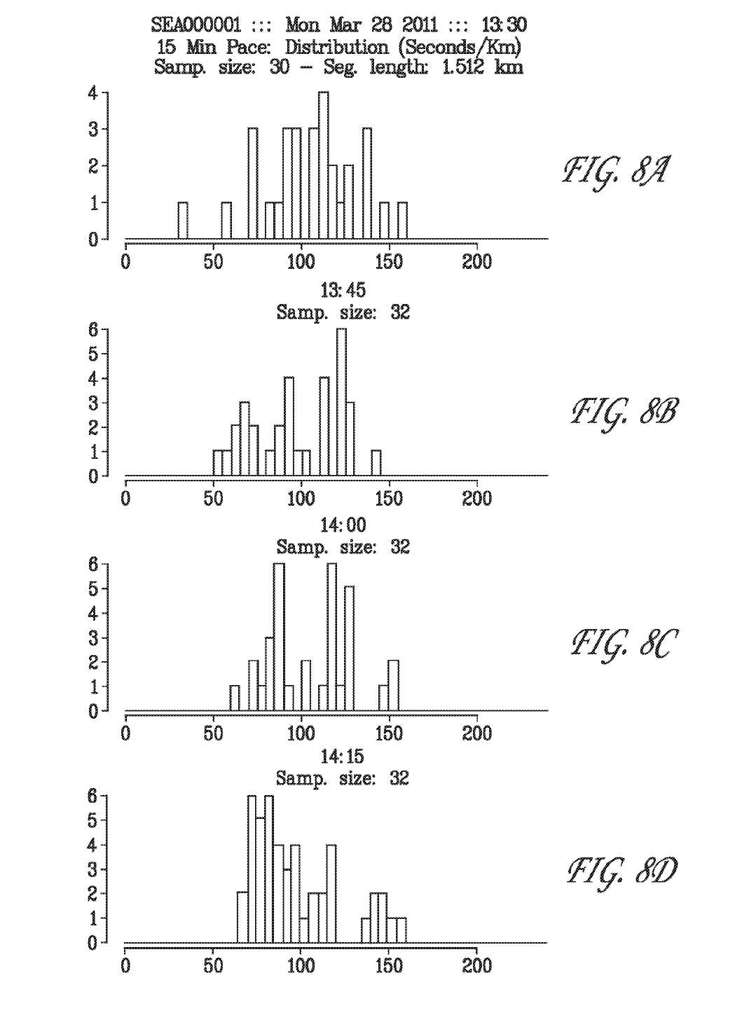

FIG. 7 is another graph showing variations in pace throughout different time periods in a day. FIG. 7 represents an exemplary data set from a different arterial segment than those illustrated in FIGS. 4, 5, and 6. Namely, FIG. 7 illustrates an exemplary data set from segment CHV001004 in Chula Vista, Calif. As in FIGS. 4-6, the boxes indicate the 25^{th}, 50^{th} (black dot), and 75^{th} percentiles, while the dotted lines or “whiskers” extend to the minimum and maximum.

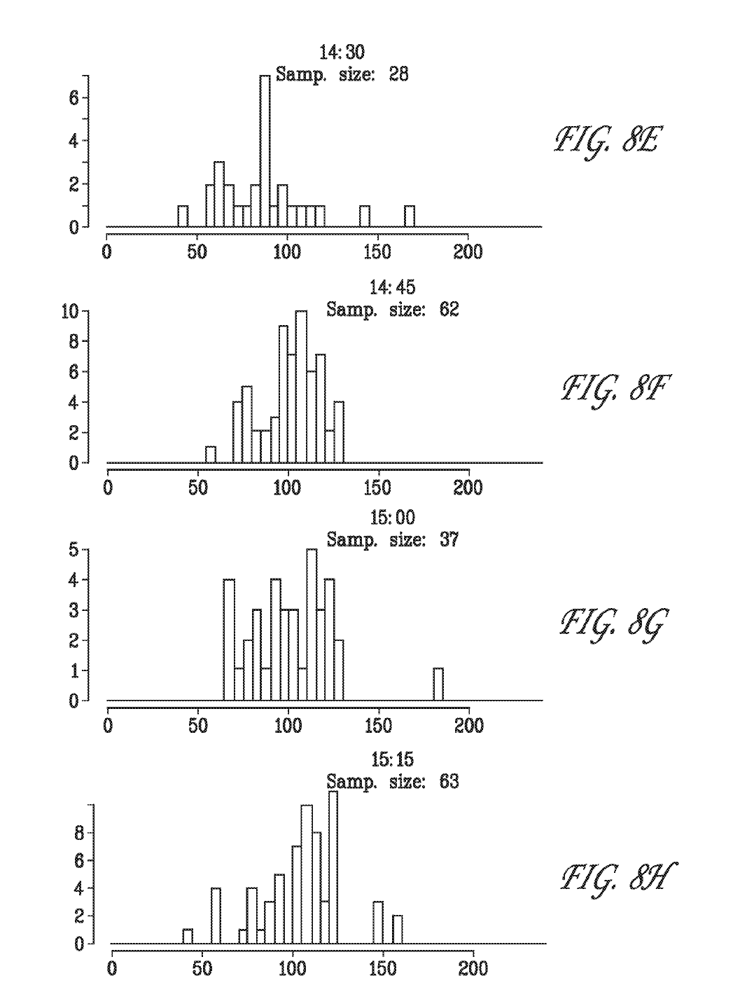

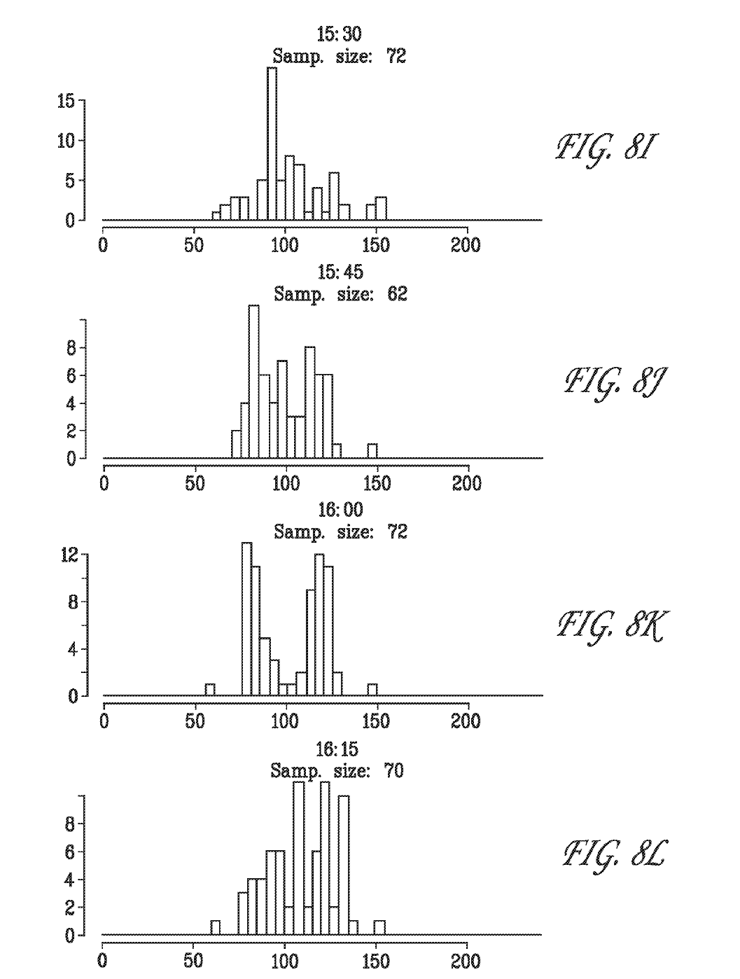

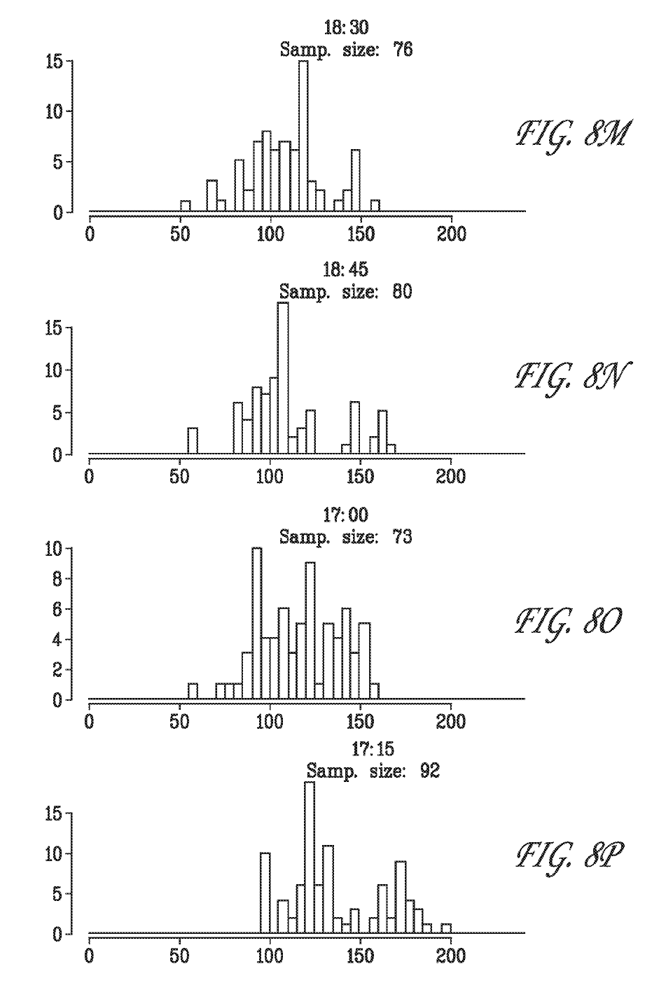

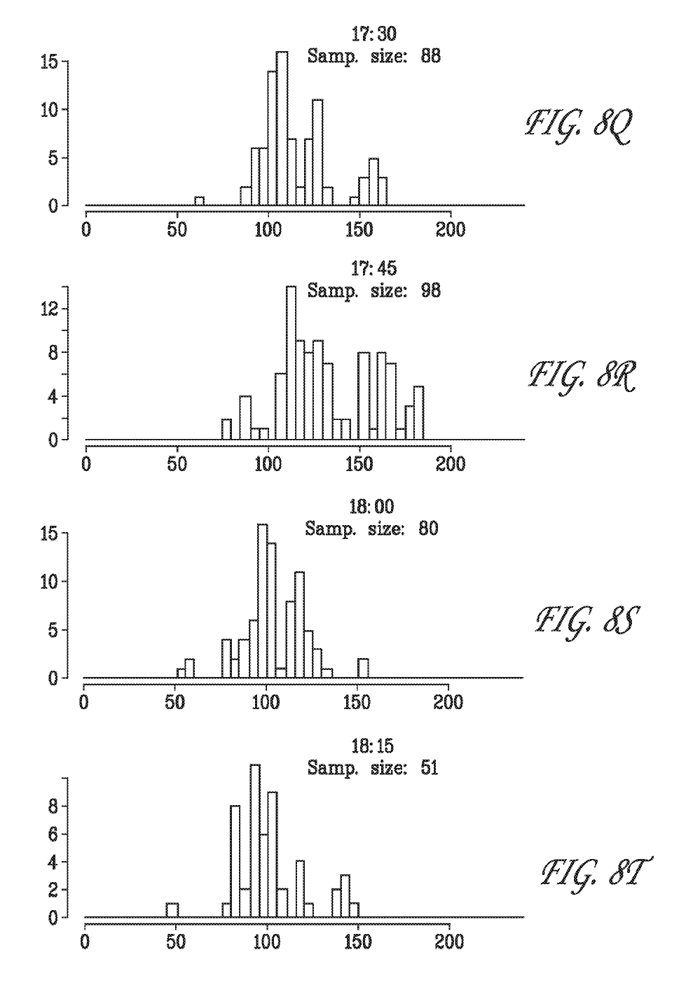

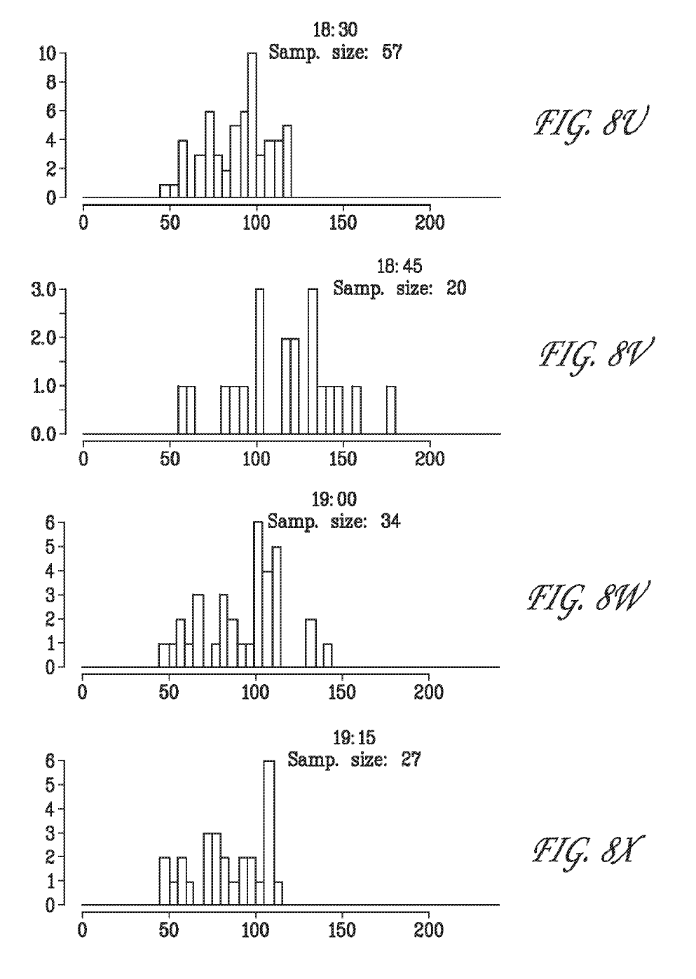

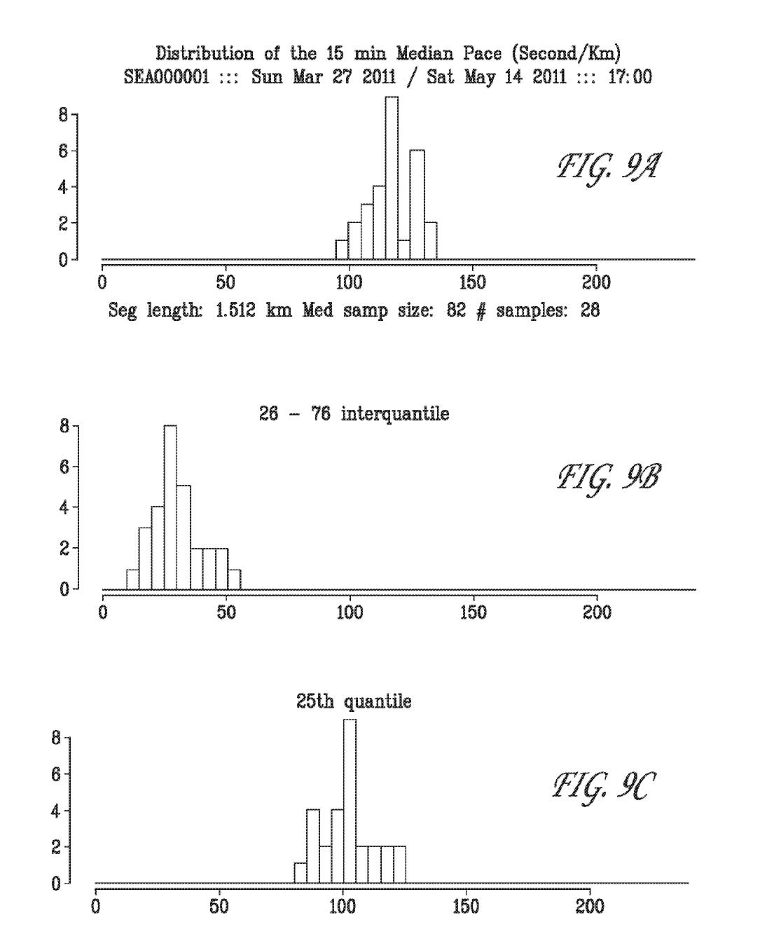

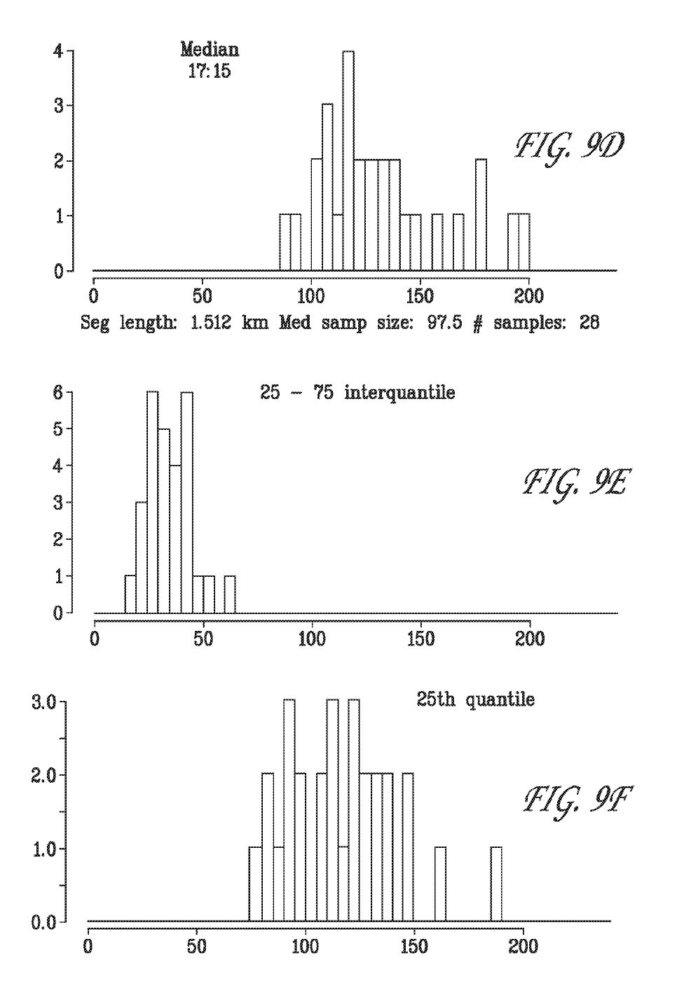

FIG. 8 is series of histograms showing that illustrates the diversity of possible distribution shapes generated by the system and methods disclosed herein. Specifically, FIG. 8 displays histograms for sequential fifteen-minute periods on a particular day between 1:30 PM and 4:30 PM. The histograms shown in FIG. 8 reveal a variety of distribution forms. System 100 may generate one or more of those forms depending on the system configuration and the data collection goal. Those forms may include relatively uniform distribution forms, forms featuring a sharp peak, or forms clearly exhibiting multiple modes.

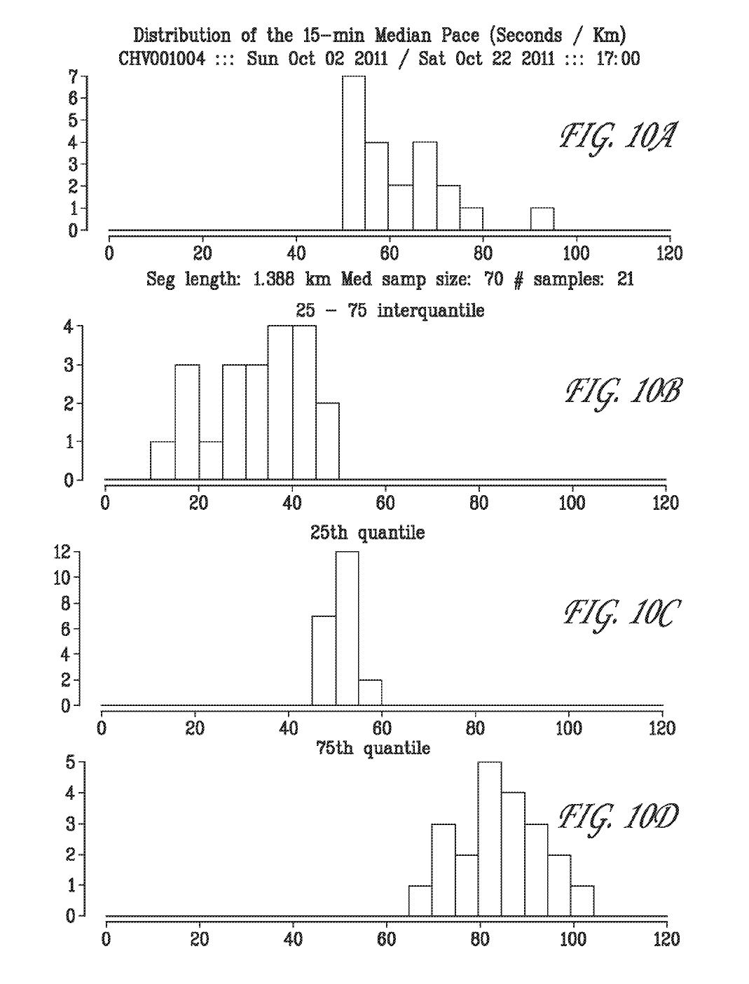

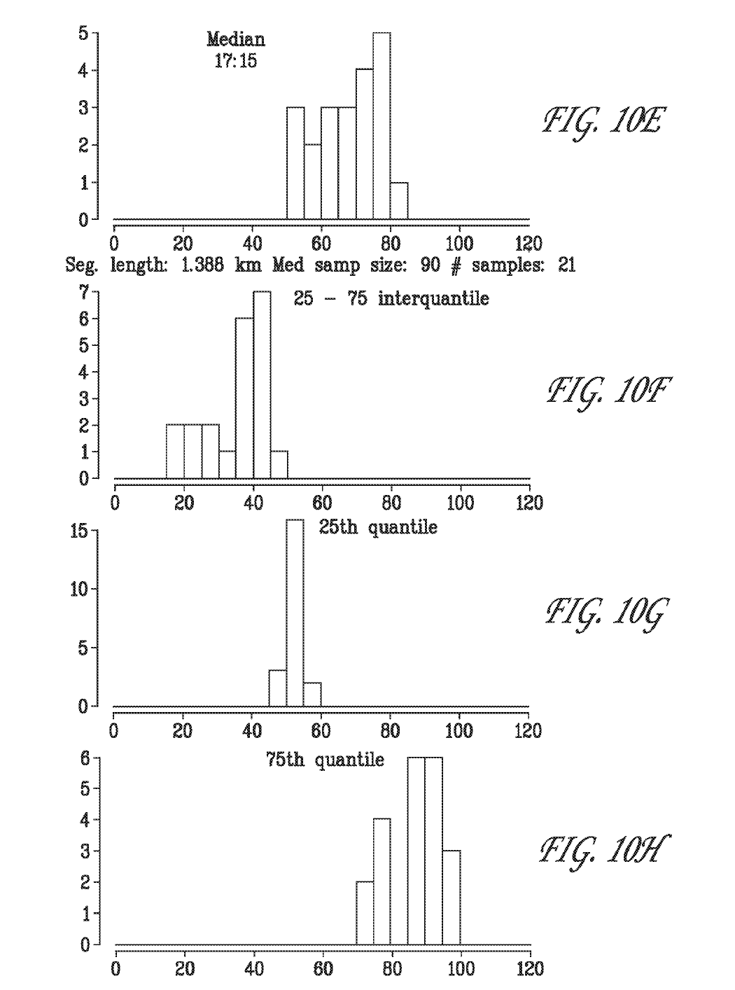

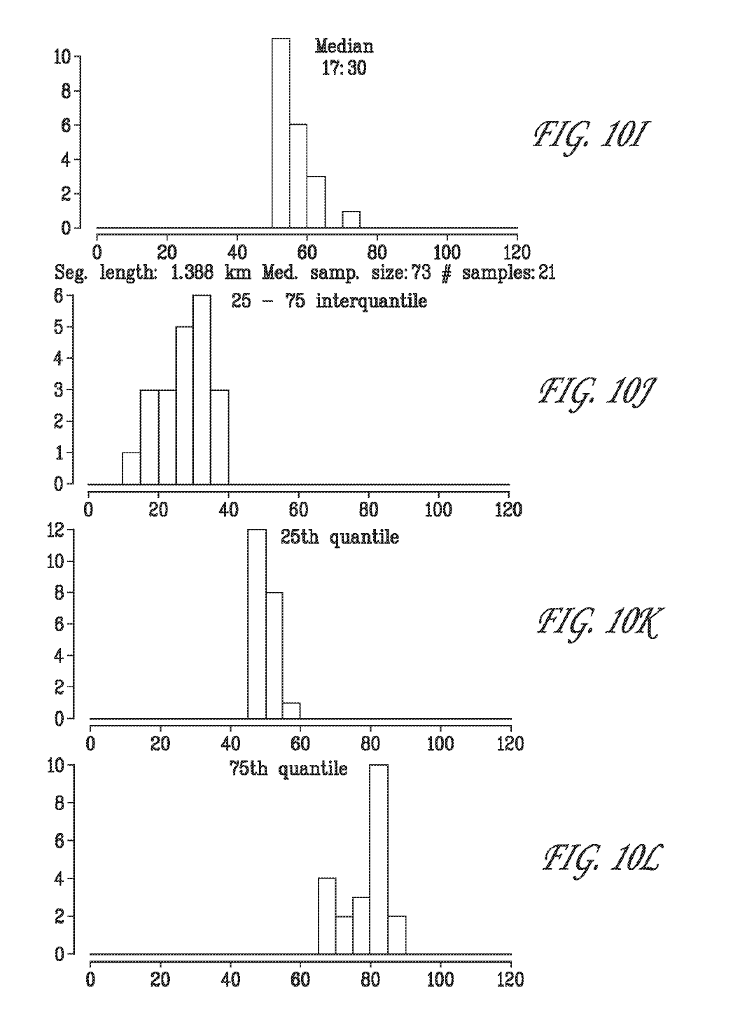

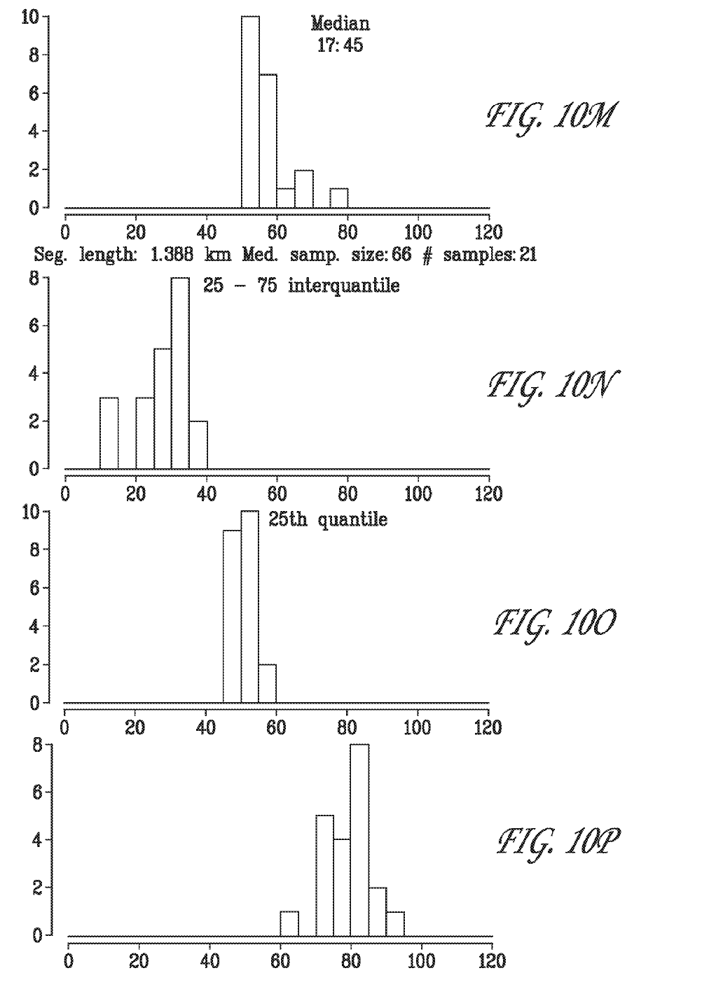

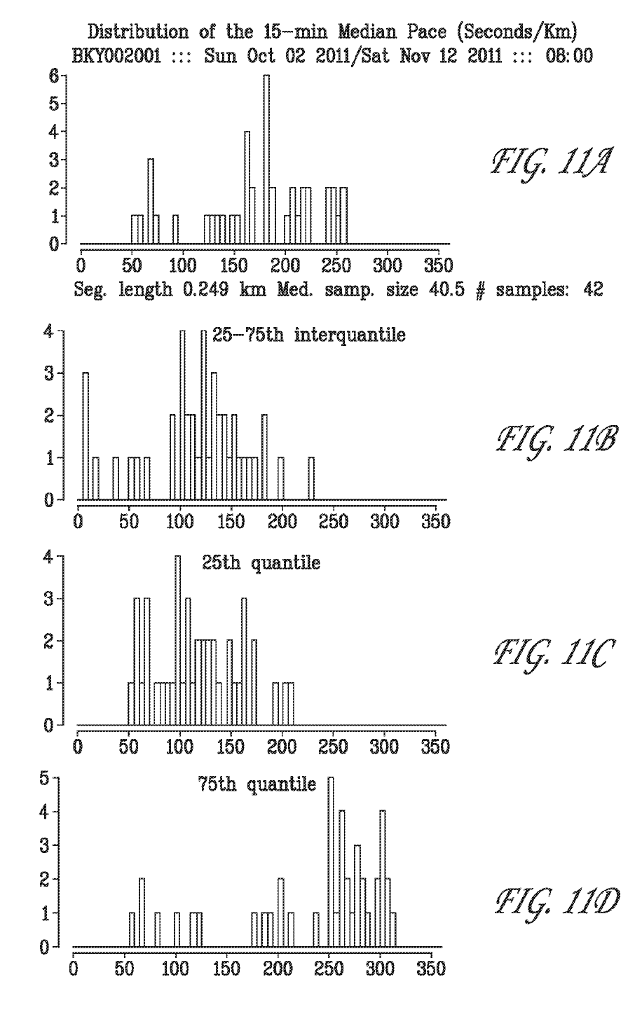

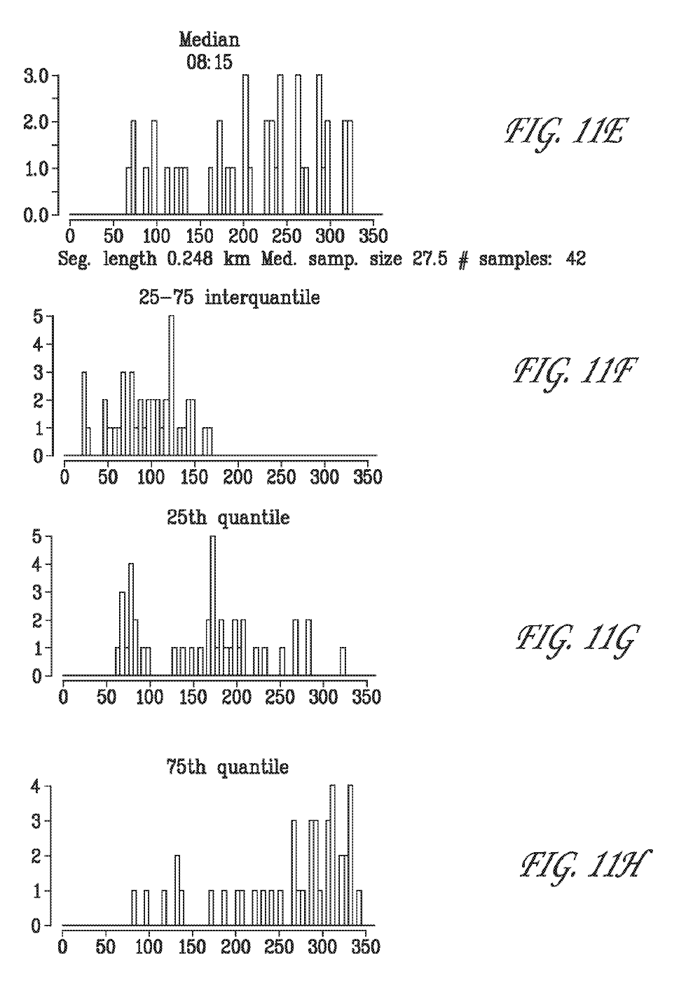

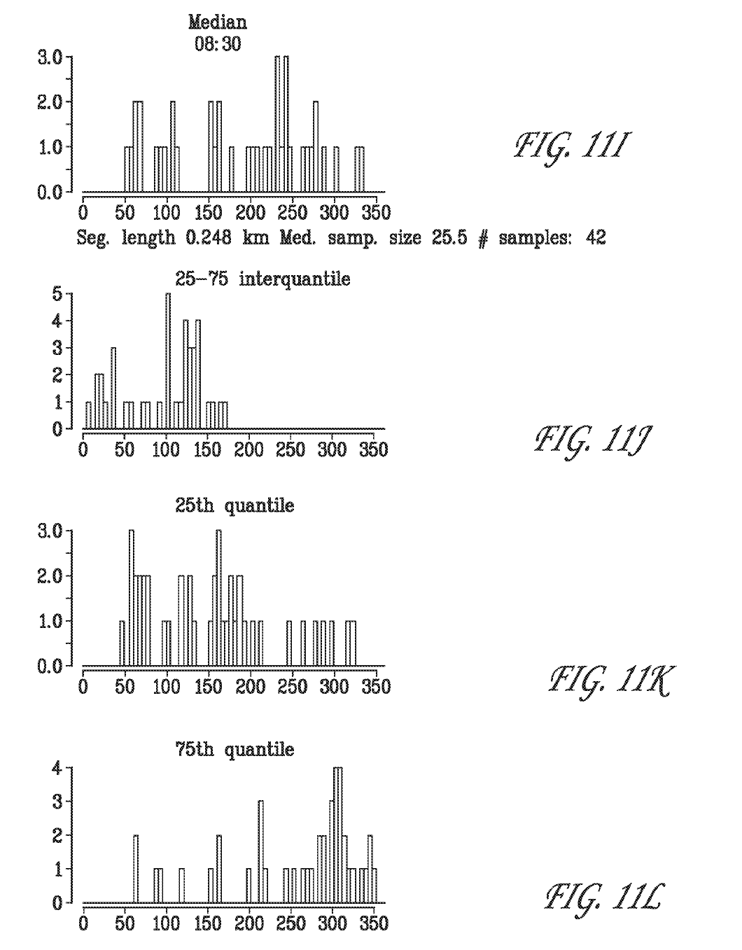

FIG. 9 is another series of graphs showing the distribution of certain parameters for two consecutive time slots from approximately 30 days of data. The parameters shown may be extracted by system 100 from the individual time distributions and may include the 25^{th} percentile, median, and 75^{th} percentile, and determine the rage of the variations contained therein. As shown in FIG. 9, system 100 may determine when certain periods of time are likely to be more congested on a signalized arterial segment. In one exemplary scenario, as shown in FIG. 9, the median reveals seven or eight congested days at 5:15 PM, while it reveals that the traffic is relatively tamer at 5 PM. FIG. 9 further illustrates the absolute distribution of quantiles across different days, but not necessarily the correlation between the quantile variations. FIGS. 10 and 11 are further series of graphs showing exemplary quantile distributions. As discussed below, a more comprehensive traffic estimation model may be generated by calibrating travel time distribution models from quantile values.

FIG. 12 is a series of scatter plots mapping quantiles against one another. More specifically, FIG. 12 maps the 75^{th} quantile against the 25^{th} quantile, as well as the 25-75 interquantile against the median. FIG. 12 shows distributions over 30 days for a timeslot spanning 6 PM to 8 PM. Accordingly, each dot on either plot represents a single fifteen-minute distribution of pace that took place between 6 PM and 8 PM. As shown in FIG. 12, system 100 may determine that the 75^{th} and 25^{th} appear correlated, for example being no more than 50 seconds/kilometer apart. Such results indicate that inter-vehicular travel time variations are not insignificant but remain limited. In other instances, the correlation between quantiles may be less, corresponding to more disorganized traffic conditions.

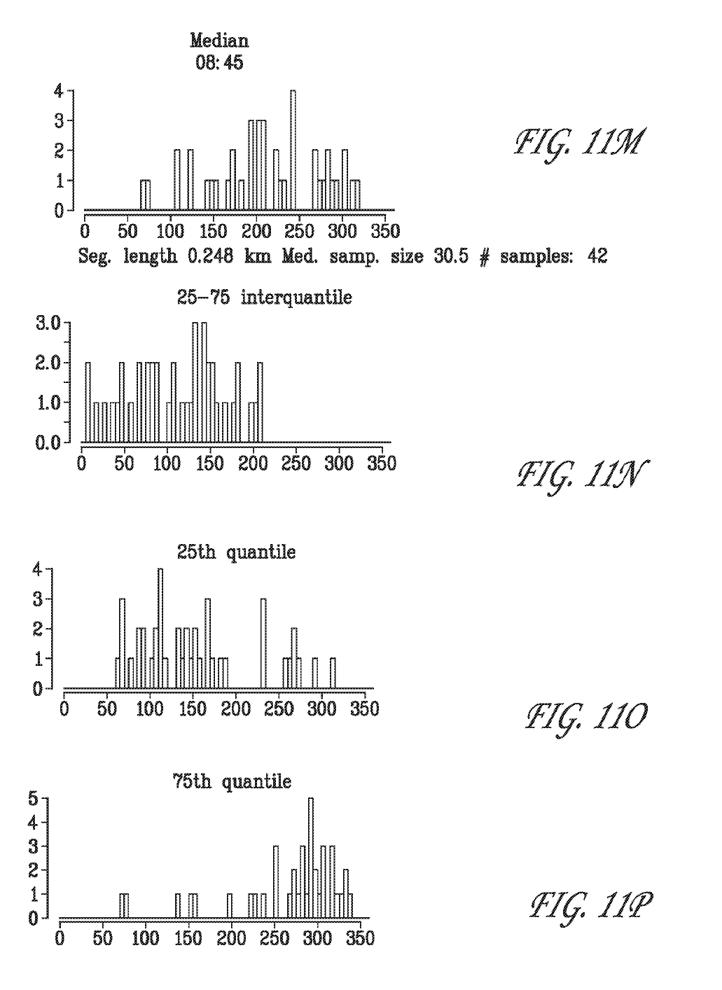

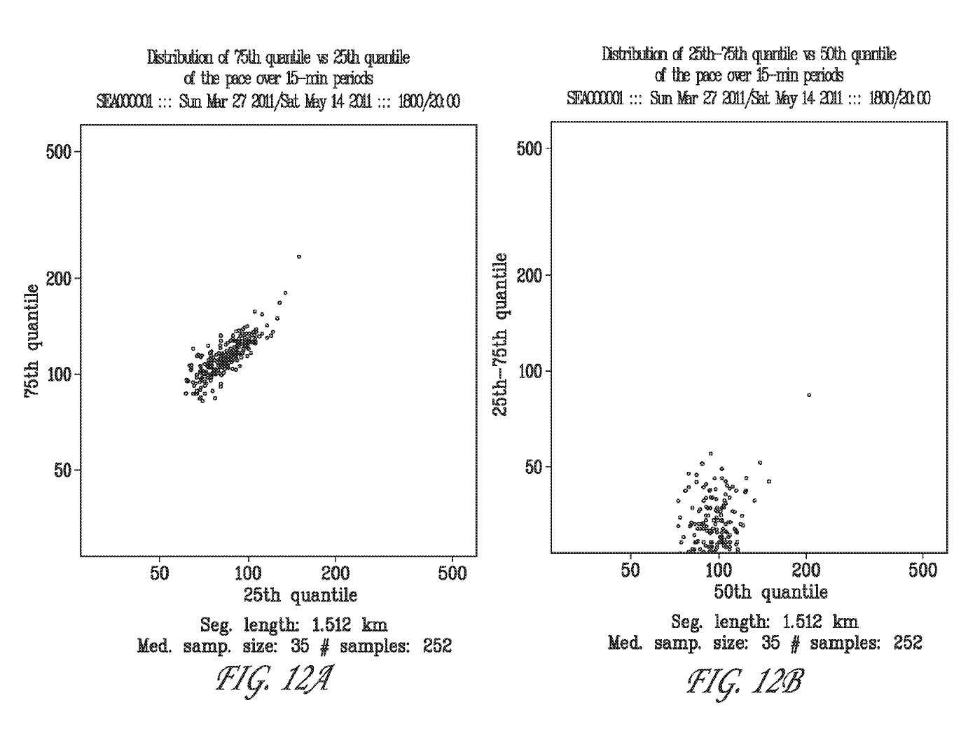

FIG. 13 is another series of scatter plots mapping quantiles against one another. FIG. 13 maps quantiles from three different locations: Chula Vista, Calif., Seattle, Wash., and Berkeley, Calif.

The system and methods disclosed herein reveal that some segments exhibit relatively little dispersion and only minor fluctuations throughout the day, while other segments seem to constantly induce delays. In some cases, travel times appear neatly distributed around a single mode. In other instances, the shape of the distribution may suggest more of a continuum. The system and methods described herein fulfill the need for a flexible model that allows different distribution shapes and can therefore provide a good to the data. To avoid being constrained by limited number of observations and low sample sizes (and posing a serious risk of over-fitting by allowing multiple dimensions for the parameter θ_{T}), system 100 may analyze data by focusing on key percentile values as proxy descriptors for the travel time distributions. System 100 may calibrate prior distributions by analyzing density plots such as those described above over substantial periods of time. In doing so, system 100 may use universal pace distributions such that system 100 may perform Bayesian calibrations and estimations.

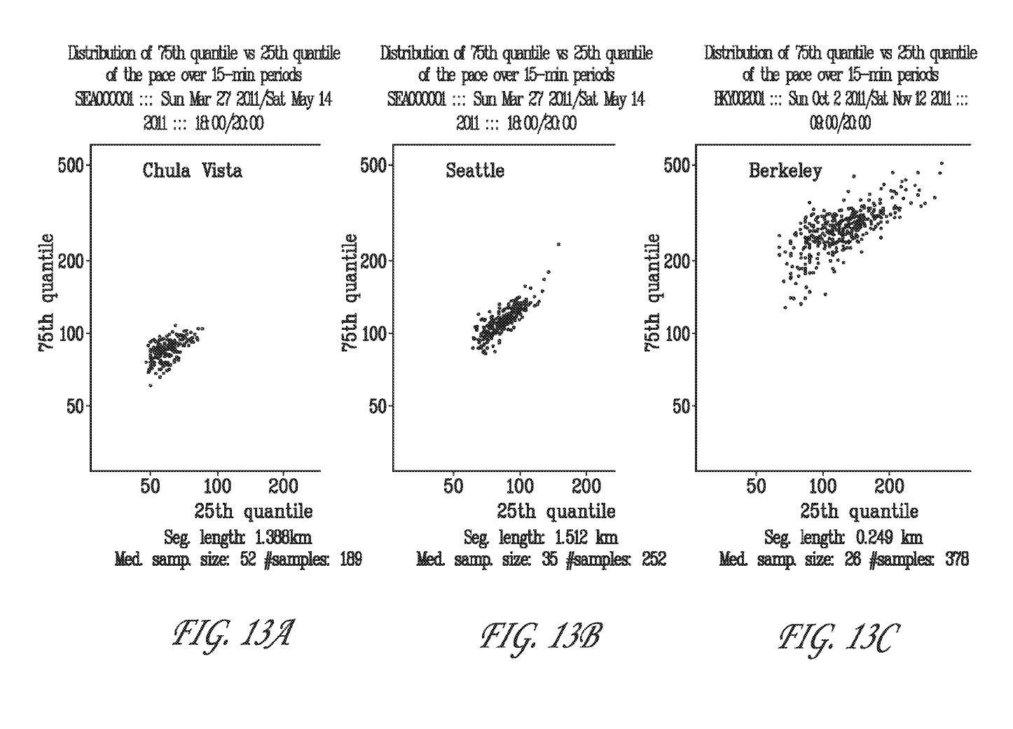

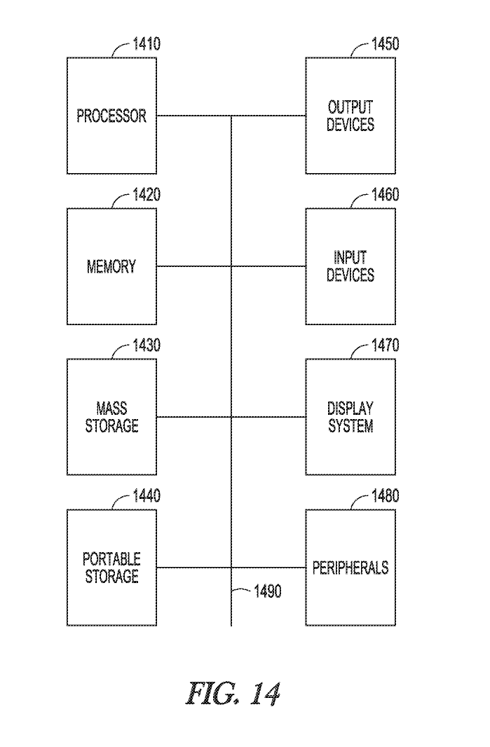

FIG. 14 is a block diagram of a device 1400 for implementing an embodiment of the technology disclosed herein. System 1400 of FIG. 14 may be implemented in the contexts of the likes of client computer 110 and server computer 130. The computing system 1400 of FIG. 14 includes one or more processors 1410 and memory 1420. Main memory 1420 may store, in part, instructions and data for execution by processor 1410. Main memory can store the executable code when in operation. The system 1400 of FIG. 14 further includes a storage, which may include mass storage 1430 and/or portable storage 1440, output devices 1450, user input devices 1460, a display system 1470, and peripheral devices 1480. Although not shown, system 1400 may also include one or more antenna.

The components shown in FIG. 14 are depicted as being connected via a single bus 1490. The components may, however, be connected through one or more means of data transport. For example, processor unit 1410 and main memory 1420 may be connected via a local microprocessor bus, and the storage, including mass storage 1430 and/or portable storage 1440, peripheral device(s) 1480, and display system 1470 may be connected via one or more input/output (I/O) buses. In this regard, the exemplary computing device of FIG. 14 should not be considered limiting as to implementation of the technology disclosed herein. Embodiments may utilize one or more of the components illustrated in FIG. 14 as might be necessary and otherwise understood to one of ordinary skill in the art.

The storage device may include mass storage 1430 implemented with a magnetic disk drive or an optical disk drive, may be a non-volatile storage device for storing data and instructions for use by processor unit 1410. The storage device may store the system software for implementing embodiments of the system and methods disclosed herein for purposes of loading that software into main memory 1420.

Portable storage device 1440 operates in conjunction with a portable non-volatile storage medium, such as a floppy disk, compact disk or digital video disc, to input and output data and code to and from the computer system 1400 of FIG. 14. The system software for implementing embodiments of the system and methods disclosed herein may be stored on such a portable medium and input to the computer system 1400 via the portable storage device.

Antenna 440 may include one or more antennas for communicating wirelessly with another device. Antenna 440 may be used, for example, to communicate wirelessly via Wi-Fi, Bluetooth, with a cellular network, or with other wireless protocols and systems including but not limited to GPS, A-GPS, or other location based service technologies. The one or more antennas may be controlled by a processor 1410, which may include a controller, to transmit and receive wireless signals. For example, processor 1410 execute programs stored in memory 412 to control antenna 440 transmit a wireless signal to a cellular network and receive a wireless signal from a cellular network.

The system 1400 as shown in FIG. 14 includes output devices 1450 and input device 1460. Examples of suitable output devices include speakers, printers, network interfaces, and monitors. Input devices 1460 may include a touch screen, microphone, accelerometers, a camera, and other device. Input devices 1460 may include an alpha-numeric keypad, such as a keyboard, for inputting alpha-numeric and other information, or a pointing device, such as a mouse, a trackball, stylus, or cursor direction keys.

Display system 1470 may include a liquid crystal display (LCD), LED display, or other suitable display device. Display system 1470 receives textual and graphical information, and processes the information for output to the display device.

Peripherals 1480 may include any type of computer support device to add additional functionality to the computer system. For example, peripheral device(s) 1480 may include a modem or a router.

The components contained in the computer system 1400 of FIG. 14 are those typically found in computing system, such as but not limited to a desk top computer, lap top computer, notebook computer, net book computer, tablet computer, smart phone, personal data assistant (PDA), or other computer that may be suitable for use with embodiments of the technology disclosed herein and are intended to represent a broad category of such computer components that are well known in the art. Thus, the computer system 1400 of FIG. 14 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

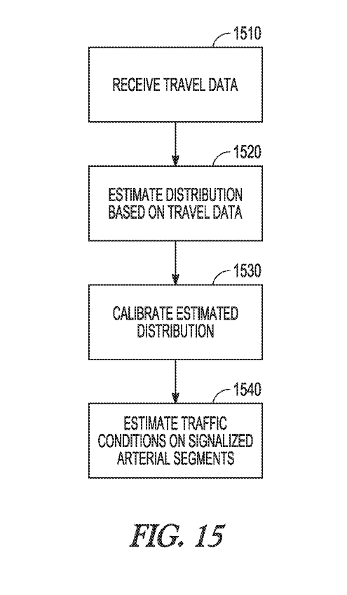

FIG. 15 shows an exemplary method for estimating traffic on signalized arterials. In an embodiment, method 1500 may include receiving travel data at step 1510. As noted above, travel data may be received from mobile GPS devices, reidentification technologies, or from a third-party server that pre-collected data. Method 1500 may further include executing instructions stored in memory, wherein execution of the instructions by a computer processor estimates a distribution based on the traffic data. At step 1530, execution of the instructions by a processor may further calibrate the distribution estimated in step 1520. In some embodiments, at step 1540, method 1500 may further include estimating the traffic conditions on a particular arterialized segment at a particular time based on the calibrated distribution. Method 1500 may also include displaying the estimated traffic conditions through a graphical interface, such as on a mobile device belonging to a user. Method 1500 of FIG. 15 may be implemented by system 100 of FIG. 1.

As discussed above, the system disclosed herein builds historical knowledge about traffic conditions by accumulating measurements over time. The system then calibrates model for different times of the day and updates those models with current available data. In some embodiments, system 100 may utilize several thousands of data plots. Moreover, as discussed above, system 100 may utilize three different sources of variability: individual, daily, and day-to-day. In situations where no current data is available, the historical data alone may be used. In situations in which current data is available, such as data received by system 100 from reidentification devices, system 100 may update the historical knowledge accordingly using the Bayesian interface discussed above. In some embodiments, quantile maps like those discussed above may be utilized to accomplish such estimations.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. (canceled)

2. A system for estimating time travel distributions on signalized arterials, comprising:
a processor;
memory; and
an application stored in memory and executable by the processor to:
receiving travel data from one or more re-identification devices;
estimating a first distribution on one or more signalized arterials based on the received travel data; and
calibrating the first distribution to obtain a second distribution, wherein the second distribution is a more recent estimate of travel time compared to the first distribution.

3. The system of claim 2, wherein the re-identification device is a magnetic signature.

4. The system of claim 2, wherein the re-identification device is a toll tag.

5. The system of claim 2, wherein the re-identification device is a license plate.

6. The system of claim 2, wherein the re-identification device is a Bluetooth receiver.

7. The system of claim 2, wherein the received travel data includes travel time observation of the one or more signalized arterials of interest.

8. The system of claim 2, wherein the received travel data includes travel time observation of one or more nearby signalized arterials to the one or more signalized arterials of interest.

9. The system of claim 2, wherein the received travel data includes contextual evidence associated with the one or more signalized arterials of interest.

10. The system of claim 2, wherein the first distribution comprises a linear combination of individual paces weighted by distance traveled.

11. The system of claim 2, wherein the operations further comprise incorporating travel time variability components with the estimated first distribution.

12. The system of claim 11, wherein the travel time variability components include at least one of individual variations, time-of-day variations, or daily variations.

13. A method for estimating time travel distributions on signalized arterials, comprising:
receiving travel data from one or more re-identification devices;
estimating a first distribution on one or more signalized arterials based on the received travel data; and
calibrating the first distribution to obtain a second distribution, wherein the second distribution is a more recent estimate of travel time compared to the first distribution.

14. The method of claim 13, wherein the re-identification device is a magnetic signature.

15. The method of claim 13, wherein the re-identification device is a toll tag.

16. The method of claim 13, wherein the re-identification device is a license plate.

17. The method of claim 13, wherein the re-identification device is a Bluetooth receiver.

18. The method of claim 13, wherein the received travel data includes travel time observation of the one or more signalized arterials of interest.

19. The method of claim 13, wherein the received travel data includes travel time observation of one or more nearby signalized arterials to the one or more signalized arterials of interest.

20. The method of claim 13, wherein the received travel data includes contextual evidence associated with the one or more signalized arterials of interest.

21. The method of claim 13, further comprising incorporating travel time variability components with the estimated first distribution.
